(19) United States
(12) Patent Application Publication
(10) Pub. No.: US 2014/0114813 A1
(43) Pub. Date: Apr. 24, 2014

(54) SHARING OF LINKS AMONG SUPPLIERS IN A NETWORK SYSTEM FOR DISTRIBUTING PRODUCTS FROM SUPPLIERS TO CONSUMERS

(71) Applicant: QUIVERS, INC., Morro Bay, CA (US)

(72) Inventors: Brant W. Berger, Morro Bay, CA (US); Jon Jason Linker, Morro Bay, CA (US); Ruben L. Martin, Eureka (CA)

(21) Appl. No.: 13/840,798

(22) Filed: Mar. 15, 2013

Related U.S. Application Data
(60) Provisional application No. 61/717,365, filed on Oct. 23, 2012.

(51) Int. Cl. G06Q 30/06

(52) U.S. Cl. CPC G06Q 30/0627
USPC 705/26.63

(57) ABSTRACT

This invention relates to systems and methods for manufacturers, distributors, and vendors (“suppliers”) that participate in a system and method of distributing products over a network from suppliers to consumers to invite each other to share links on each other's product pages. A supplier may partner with selected suppliers so that only the products of those selected suppliers are included in the cross-traffic ads and offers on its website or product page.

### CROSS-REFERENCE TO RELATED APPLICATIONS

This application is related to U.S. patent application Ser. No. 13/008,766, filed Jan. 18, 2011, which is a division of U.S. patent application Ser. No. 10/665,841, filed Sep. 19, 2003, now U.S. Pat. No. 7,855,856, which in turn is a continuation-in-part of U.S. patent application Ser. No. 09/388,999, filed Sep. 1, 1999, abandoned, all of which are incorporated herein by reference in their entirety for all purposes. Priority is claimed of U.S. Provisional Application Ser. No. 61/717,365, filed Oct. 23, 2012, which is incorporated herein by reference in its entirety for all purposes.

### BACKGROUND OF THE INVENTION

This invention relates to systems and methods for manufacturers, distributors, and vendors (“suppliers”) that participate in a system and method of distributing products over a network from suppliers to consumers to invite each other to share links on each other's product pages.

Suppliers (e.g., manufacturers, distributors, and vendors) have one or more channels by which to distribute products (i.e., goods and services) to consumers. A supplier's distribution channel often will include one or more retailers, each of which typically specializes in selling a particular class of products to consumers. For example, some retailers specialize in selling only high end, high margin products, whereas other retailers specialize in selling low end (or medium end) products. Some suppliers distribute some or all of their products to consumers directly, without involving retailers.

Recently, there has been a trend toward distributing products to consumers over a computer network (e.g., the Internet). For example, some retailers and some suppliers have developed systems for displaying products to consumers and receiving consumer purchase requests over the Internet. Systems designed to coordinate the sales of products offered by a plurality of retailers to create a “virtual mall” have been proposed. On-line sales of products enable such products to be sold at lower prices as a result of the inherent efficiencies provided by on-line sales systems.

When a particular retailer elects to offer its products on-line, the existing distribution system of a supplier of that retailer may be disrupted. Typically only large volume low end (and possibly medium end) retailers have the resources and the consumer recognition to successfully offer products on-line; high end specialty retailers generally cannot launch a successful on-line sales program. Thus, in order for suppliers to sell their high end (and possibly medium end) products on-line, manufacturers have two conventional choices: the suppliers must distribute these products on-line themselves, or the suppliers must provide these products to the low end (and possibly medium end) retailers that have successfully launched on-line sales programs. Either of these approaches, however, is likely to significantly reduce the sales volumes of the high end retailers. Under these circumstances, such suppliers may lose one or more of its high end, “brick and mortar” distribution channels because high end retailers may elect to not carry the high end products of suppliers whose local sales they do not exclusively control.

The present invention is directed to a method of allowing cross-traffic of products between manufacturers on a system that protects against reducing sales of the retailers by competing with their suppliers on the same network. The present methods of cross traffic involves eCommerce sites that allow posting of other “viewed products” or “suggested products” or “customers who purchased this also purchased this” on a supplier's site. However, under current methods the supplier has no control over which other products are posted since these are determined by an algorithm. Other current options for cross-trafficking are offered through search engines ads. These work through permission on the website to allow ads offering similar or related products identified through the search engine. In this instance, the supplier of the target products on its website still has no control over the specific brand or product of the suggested products that are advertised on its site via the search engine.

The present invention provides a method whereby a supplier can partner with selected suppliers so that only the products of those selected suppliers are included in the cross-traffic ads and offers on its website or product page.

### SUMMARY OF THE INVENTION

In one aspect, the invention features a method for coordinating the distribution of products from a plurality of product manufacturers, distributors and vendors (suppliers) wherein each of the suppliers is an entity having at least one distribution channel that involves a retail establishment, to consumers from a network comprising a server comprising a graphical consumer interface accessible over the internet, the method comprising:

providing access to the graphical consumer interface by consumers over the internet, the interface configured to display product information including price and availability to consumers for products from the plurality of suppliers and configured to receive consumer product orders directly from consumers to any of the suppliers on behalf of a plurality of suppliers; wherein price and availability information for the products of each of the suppliers are organized by product category on a product page of each respective supplier, wherein the appearance of products and ads on each supplier's product page is under control of the supplier;

enabling a consumer to search through the products of a given category by supplier, by product type, by product feature, or by a combination of two or more of these identifiers;

enabling a first supplier to select to invite a second supplier to be linked such that:

a search by consumers over the internet on the graphical consumer interface that leads to a product or product of the first supplier will display a link on the first supplier's product page to a related product or products of the second supplier; and

a search by consumers over the internet on the graphical consumer interface that leads to a product or product of the second supplier will display a link on the second supplier's product page to a related product or products of the first supplier;

enabling the second supplier to accept or refuse to be linked to the first supplier;

if the second supplier accepts to be linked to the first supplier, establishing connections on the graphical user interface to link products of the second supplier as suggested products on the first supplier's product page related to products of the first supplier, and establishing connections on the graphical user interface to link products of the first supplier as suggested products on the second supplier's product page related to products of the second supplier.

In another aspect, the invention features an embodiment of the method wherein after acceptance of the second supplier to be linked to the first supplier, a fee or a percentage of sales of the second supplier's products from the second supplier's product page resulting from consumers linking to the second supplier's product page from the first supplier's product page is credited to the first supplier.

In another aspect, the invention features an embodiment of the method wherein after acceptance of the second supplier to be linked to the first supplier, a fee or a percentage of sales of the first supplier's products from the first supplier's product page resulting from consumers linking to the first supplier's product page from the second supplier's product page is credited to the second supplier.

In one aspect, the method may feature an embodiment wherein a group of suppliers agree to be linked on each other's respective product pages.

In another aspect, the invention features a network for coordinating the distribution of products from a plurality of suppliers to consumers wherein each of the suppliers is an entity having at least one distribution channel that involves a retail establishment, the network comprising a server comprising

a graphical consumer interface accessible by consumers over the internet configured to display product information including price and availability to consumers for products from the plurality of suppliers and to receive product orders from consumers directly to any of the plurality of suppliers; wherein price and availability information for the products of each of the suppliers are organized by product category on a product page of each respective supplier, wherein the appearance of products and ads on each supplier's product page is under control of the supplier;

the graphical consumer interface configured to enable a consumer to search through the products of a given category by supplier, by product type, by product feature, or by a combination of two or more of these identifiers;

a back room manager accessible only to the suppliers configured

to enable a first supplier to select to invite a second supplier to be linked such that:

a search by consumers over the internet on the graphical consumer interface that leads to a product or product of the first supplier will display a link on the first supplier's product page to a related product or products of the second supplier; and

a search by consumers over the internet on the graphical consumer interface that leads to a product or product of the second supplier will display a link on the second supplier's product page to a related product or products of the first supplier;

the back room manager configured to enable the second supplier to accept or refuse to be linked to the first supplier; whereby

if the second supplier accepts to be linked to the first supplier, the back room manager is configured to establish connections on the graphical user interface to link products of the second supplier as suggested products on the first supplier's product page related to products of the first supplier, and to establish connections on the graphical user interface to link products of the first supplier as suggested products on the second supplier's product page related to products of the second supplier.

In another aspect, the invention features an embodiment of the network comprising an account manager configured to distribute after acceptance of the second supplier to be linked to the first supplier, a fee or a percentage of sales of the second supplier's products from the second supplier's product page resulting from consumers linking to the second supplier's product page from the first supplier's product page is credited to the first supplier.

In another aspect, the invention features an embodiment of the network wherein the account manager is configured after acceptance of the second supplier to be linked to the first supplier, a fee or a percentage of sales of the first supplier's products from the first supplier's product page resulting from consumers linking to the first supplier's product page from the second supplier's product page is credited to the second supplier.

Embodiments of a network according to the invention may include one or more of the following features.

The order flow controller may be configured to route consumer orders for one or more products of a given supplier to that supplier in accordance with that supplier's selected fulfillment policy. The order flow controller may be configured to route consumer orders for one or more products of a given supplier to one or more retailers identified by that supplier in accordance with that supplier's selected fulfillment policy. Also, the order flow controller may be configured to not accept consumer orders for one or more products of a given supplier in accordance with that supplier's selected fulfillment policy. The order flow controller may be configured to route consumer orders for one or more products of a given supplier to a product order list accessible by one or more retailers identified by that supplier in accordance with that supplier's selected fulfillment policy.

The network may include a back room manager configured to remove product orders from the product order list upon receipt of a fulfillment acceptance indication from a retailer. The partnering among manufacturers and suppliers may be accomplished using a back room manager configured to be accessible only to suppliers. The back room manager may be configured to enable the given supplier to fulfill selected product orders identified on the product order list. The back room manager may be configured to enable the given supplier to fulfill selected product orders identified on the product order list only after a preselected period of time has passed since the product order was received.

The consumer interface preferably is configured to display price and availability information for the products of each of the suppliers organized by product category. The system may include a search engine configured to enable a consumer to search through the products of a given category by supplier, by product type, by product feature, or by a combination of two or more of these identifiers.

The consumer interface may be configured to enable a consumer to display selected product representations in a separate scratch pad window. The consumer interface may be configured to enable a consumer to remove product representations from the scratch pad window. The consumer interface may be configured to enable a consumer to drag a selected product representation from a product previews window to the scratch pad window. The consumer interface may be configured to enable a consumer to initiate a product order from the scratch pad window or from the product preview window, or from both windows.

The network may include a price filter configured to transmit product price information and product availability information to the consumer interface. The price filter may be configured to transmit supplier specified product prices. The price filter may be configured to transmit retailer specified product prices during certain supplier selected periods of time. The price filter may be configured to transmit only a selected number of the lowest retailer specified product prices.

The network also may include an account manager configured to retain consumer payments for a selected period of time and to distribute retained funds. The account manager may be configured to distribute retained funds to an entity that shipped a product to a consumer. The account manager may be configured to distribute funds retained for a given product order to a supplier that fulfilled the given product order, one or more retailers identified by that supplier, or to a combination of supplier and one or more retailers. The account manager may also be configured to distribute a fee or a percentage of a supplier's sale funds to a partner supplier stemming from a sale from a referred customer from a link on the partner's product page or website. The distribution of the fee or percentage may be one way where one partner shares a portion of its sales funds with the other partner but the other partner does not reciprocate. The distribution may be reciprocal where two, or more, partners share portions of their respective sales funds with the partner whose product page or website provided the customer.

The routine features of the implementations described herein are not all shown and described in the interest of clarity. It will, of course, be appreciated that in the development of a practical implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of known or available operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

As used herein, the term “supplier” refers to any entity (e.g., manufacturers, distributors and vendors) that has at least one distribution channel that involves a retail establishment.

As used herein, a “retailer” is a brick and mortar entity used by a supplier to fulfill product orders. A participating retailer according to the invention is not directly accessible by a consumer on the graphical consumer interface over the Internet.

Also, as used herein, the term “product” refers to both goods and services.

Among the advantages of the invention are the following.

An advantage of the present invention is that suppliers may control the distribution of their products in a network environment while maintaining its traditional brick and mortar distribution channels while each supplier can partner with selected suppliers so that only the products of those selected suppliers are included in the cross-traffic ads and offers on the supplier's website or product page.

Other features and advantages will become apparent from the following description, including the drawings and the claims.

### BRIEF DESCRIPTION OF THE DRAWINGS

FIG. 1 is a block diagram showing an embodiment of a system for coordinating the distribution of products from a plurality of suppliers to consumers in a network environment into which the feature of partnering between suppliers according to the invention may be adapted.

FIG. 2 is a block diagram of the partnering method allowing suppliers to selectively partner with each other according to the invention.

### DETAILED DESCRIPTION

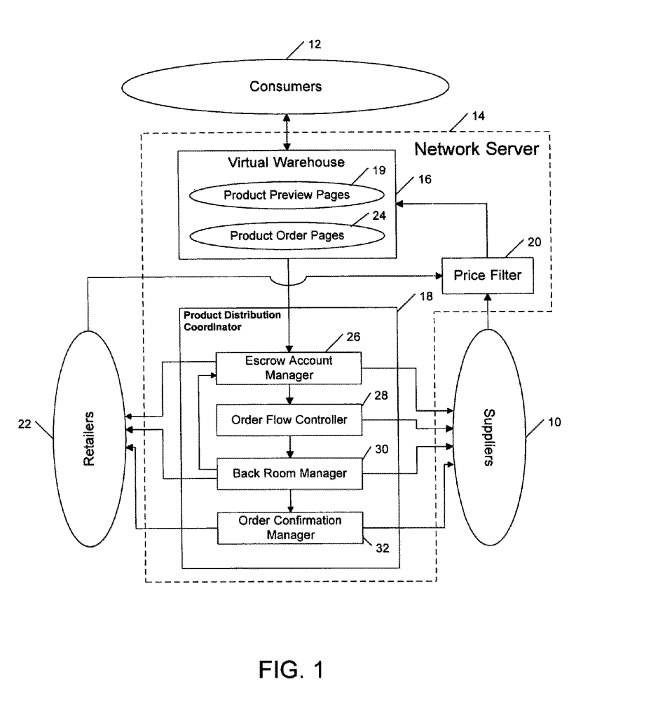

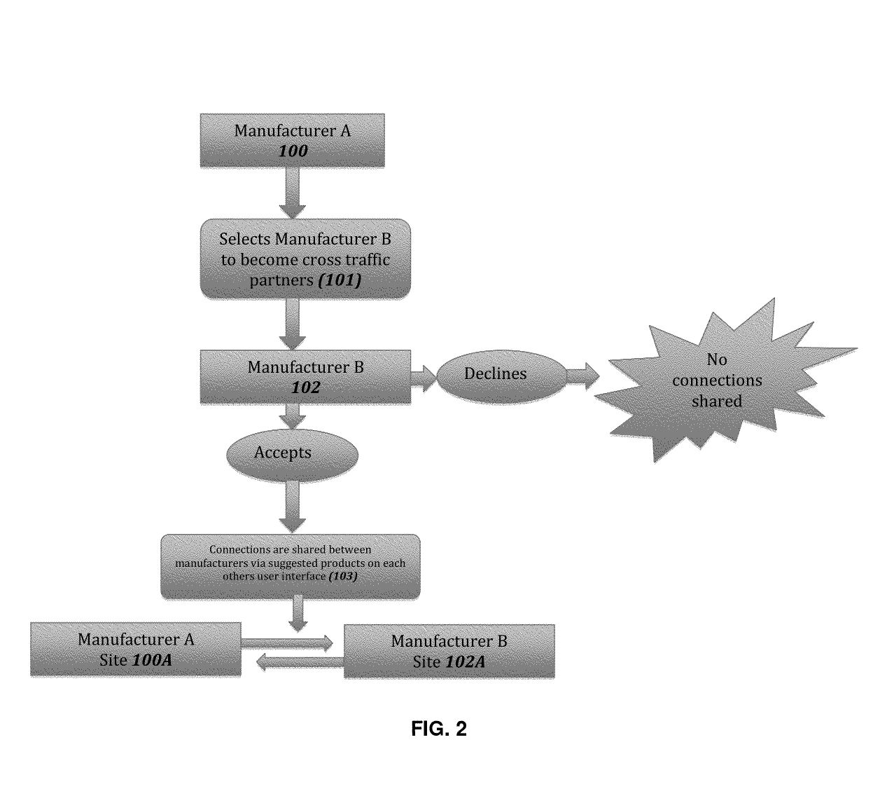

Referring to FIG. 2, once a supplier (indicated as manufacturer 100) wants to partner with a specific supplier (indicated as manufacturer 102) the recipient manufacturer 102 is notified in step 101 and either accepts or declines the offer. If accepted both manufacturers share connections in step 103 to their product links similar to “suggested products” on each other's product sites or web pages sites, 100A and 102A, such as the supplier's page accessed via a virtual warehouse 16 shown in FIG. 1. Each partner supplier will continue to operate on its own supplier site to provide its own products. But customers will also be able to view on each site product links to the partner's products. Products or ads generated by algorithms and search engines operative on the network not under control of the supplier that controls its product page have no access to the product page and will not appear.

The partnership between suppliers can also formed among a group of suppliers who agree to pay a fee or a percentage of sales if they are accepted as a partner and the consumer to whom a sale is made is steered from the partner's site from the shared connections made according to the invention. The process of partnering among suppliers in this manner may be accomplished for example using a back room manager accessible only to manufacturers and suppliers 10 that communicates with the virtual warehouse 16 shown in FIG. 1.

Referring to FIG. 1, one embodiment is shown of a network-based system for coordinating the distribution of products from a single supplier or a plurality of suppliers 10 to a plurality of consumers 12 into which the feature of partnering between suppliers according to the invention may be adapted. The network includes a network server 14 that is operable to implement a virtual warehouse 16 and a product distribution coordinator 18. Virtual warehouse 16 is accessible by consumers 12 over a network (e.g., the Internet) and includes a graphical consumer interface that is configured to present to consumers a plurality of product preview pages 19 each displaying information (e.g., price and availability) relating to a plurality of products. A price filter 20 populates product preview pages 19 with price information supplied by suppliers 10 and participating retailers 22. Consumers may order one or more of the products displayed on product preview pages 19 by entering order request data into one or more product order pages 24. Product distribution coordinator 18 is configured to process consumer product orders and to coordinate the fulfillment of product orders in accordance with fulfillment policies selected by suppliers 10.

Product distribution coordinator 18 includes an account manager 26, an order flow controller 28, a back room manager 30, and an order confirmation manager 32. Account manager extracts consumer payment information (e.g., consumer name, product description, product price, credit card number, expiration date) from product order pages 24. Account manager 26 debits the consumers' credit card accounts and holds the funds in escrow until the expiration of a preselected period of time (e.g., 30 days), at which point funds are disbursed to the appropriate entities. Order flow controller 28 extracts product order information (e.g., product description, product price) from product order pages 24 and routes the extracted product order information in accordance with supplier selected fulfillment policies, as explained in detail below. Back room manager 30 coordinates the fulfillment of product orders by retailers 22 and suppliers 10. Order confirmation manager 32 coordinates the transmission of shipment confirmation information to suppliers 10 and consumers 12.

Virtual warehouse 16, product distribution coordinator 18 and price filter 20 may be implemented in computer software using conventional computer programming techniques.

Virtual warehouse 16 may organize product preview pages 19 in a data structure including a home page which can be the page that is presented to consumers when they first access the system. The home page may include a general description of the system (including how information is organized and how to navigate through the system), and includes icons corresponding to different product categories (e.g., tools, electronics, sports, and household items). Each of the icons may represent a hyperlink to a page that includes icons corresponding to different product sub-categories. For example, a sports icon may include a hyperlink to a sports page that includes other icons which correspond to the sports sub-categories of water sports, golf, winter sports and bikes, respectively. Each of the sub-category icons may then include hyperlinks to pages that list products by category or by supplier. For example, a winter sports icon may include hyperlinks to pages which enable consumers to preview products by category and by supplier name, respectively. The products by category pages may include links to pages containing lists of products corresponding to particular product types. For example, winter sports products by category page may include links to pages listing products corresponding to the following product types: Nordic ski equipment, alpine ski equipment, mountaineering equipment, snowboarding equipment and clothing. Product listing pages may include links to other product listing pages. The products by supplier pages can then include links to pages containing lists of the products of other particular suppliers who have agreed to partner with the supplier according to the invention.

Virtual warehouse 16 may include a search engine that enables consumers to search for products by manufacturer, by product type, by product feature (e.g., product color), or by a combination of two or more of these categories.

Embodiments may use different “shopping cart” systems to enable consumers to select items that they are considering to purchase.

Price filter 20 posts prices on product preview pages 19. In one embodiment, during an “in season” shopping period suppliers provide the price information that is posted on product preview pages 19. During an off-price, sale season shopping period suppliers 10 and retailers 22 transmit their lowest prices and available quantities to price filter 20, and price filter 20 posts on product preview pages 19 a limited number (e.g., three) of the lowest prices received for the products which are on sale.

In one embodiment, product distribution coordinator 18 enables suppliers to control the way in which consumers' product orders are fulfilled. For example, a supplier may elect merely to have its products listed on product preview pages with suggested retail prices and indications that the products are not available through the system. Alternatively, a supplier may elect to fulfill all orders for its products; in which case, order flow controller 28 routes all consumer product orders to that supplier. A supplier may identify particular retailers that are able to fulfill orders for particular kinds of products. Also, a supplier may identify the product orders that it will ship, and the product orders that certain retailers may fulfill.

A supplier may elect to allow one or more retailers to have the opportunity to ship one or more of the supplier's products; in which case, order flow controller 28 routes consumer orders for these products to back room manager 30. Back room manager posts consumer product orders as a product order list on a password-protected order fulfillment page which participating retailers 22 may access over the Internet. A retailer may customize its view of the order fulfillment page to display only the products sold by that retailer. When a particular retailer elects to fulfill a posted order, back room manager 30 removes the product order from the product order list and transmits the information needed to fulfill the order to the shipping retailer. When an order is ready to ship, the shipper (manufacturer or retailer) transmits to back room manager 30 the item being shipped, the price, the shipping cost, other shipping details, the consumer's name, address and escrow number. Back room manager 30 transmits to the consumer a message confirming the shipment of the ordered product. Back room manager 30 also transmits a confirmation message to the shipper and transmits notification to escrow account manager 26, initiating the escrow period for that transaction. Suppliers may elect to ship product orders that have not been picked up by participating retailers within a preselected period of time (e.g., 24 hours). Also, suppliers may access the order fulfillment page to monitor the fulfillment status of orders for its products.

In one embodiment, product distribution coordinator 18 may choreograph the fulfillment of a product order in accordance with a particular manufacturer's order fulfillment policy as follows. If a product order has been received, order flow controller 28 routes the order to back room manager 30 which posts the product order on an order fulfillment page accessible by retailers 22. If a retailer transmits an indication that it will ship the order back room manager transmits the fulfillment information to escrow account manager 26, transmits the product order information (e.g., customer name) to the shipping retailer, transmits to the ordering consumer a notification that the order is being shipped, and removes the product order from the order fulfillment page. If the product has not been picked up by a participating retailer 22 within a preselected period of time (e.g., 24 hours), back room manager 30 transmits the product order information to the manufacturer for fulfillment, transmits the fulfillment information to escrow account manager 26, and removes the product order from the order fulfillment page.

Communications (e.g., notification and confirmation messages) that are transmitted to and from product distribution coordinator 18 preferably are transmitted electronically over the network (e.g., e-mail).

As explained above, when a consumer places an order, account manager 26 retains the funds debited from the consumers credit card account in an account for an escrow period (e.g., 30 days). After the escrow period has expired, account manager 26 disburses a portion of the retained funds to the shipper (including the shipping cost that was charged to the customer), pays a fee to the credit card company and retains a portion of the funds as a transaction fee. In cases where a supplier picks up an order for fulfillment, the supplier may instruct account manager 26 to share a portion of the shipment funds with one or more designated retailers (e.g., local retailers).

Product returns are routed to the entity (manufacturer or retailer) that shipped the product. If the escrow period has not expired, account manager 26 returns funds to the consumer from the escrow account; otherwise, the shipper's escrow account is debited for the return. Warranty returns are routed to the shipper for standard processing.

Other embodiments are within the scope of the claims.

What is claimed is:

1. A method for coordinating the distribution of products from a plurality of suppliers, wherein each of said suppliers is an entity having at least one distribution channel that involves a retail establishment, to consumers from a network comprising a server comprising a graphical consumer interface accessible over the internet, comprising:
providing access to said graphical consumer interface by consumers over the internet, said interface configured to display product information including price and availability to consumers for products from said plurality of suppliers and configured to receive consumer product orders directly from consumers to any of said suppliers on behalf of a plurality of suppliers; wherein price and availability information for the products of each of said product manufacturers are organized by product category on a product page of each respective supplier, wherein the appearance of products and ads on each supplier's product page is under control of the supplier;
enabling a consumer to search through the products of a given category by supplier, by product type, by product feature, or by a combination of two or more of these identifiers;
enabling a first supplier to select to invite a second supplier to be linked such that:
a search by consumers over the internet on the graphical consumer interface that leads to a product or product of the first supplier will display a link on the first supplier's product page to a related product or products of the second supplier; and
a search by consumers over the internet on the graphical consumer interface that leads to a product or product of the second suppliers will display a link on the second supplier's product page to a related product or products of the first supplier;
enabling the second supplier to accept or refuse to be linked to the first supplier;
if the second supplier accepts to be linked to the first supplier, establishing connections on the graphical user interface to link products of the second suppliers as suggested products on the first supplier's product page related to products of the first supplier, and establishing connections on the graphical user interface to link products of the first supplier as suggested products on the second supplier's product page related to products of the second supplier.

2. The method according to claim 1 wherein after acceptance of the second supplier to be linked to the first supplier, a percentage of sales of the second supplier's products from the second supplier's product page resulting from consumers linking to the second supplier's product page from the supplier's product page is credited to the first supplier.

3. The method according to claim 1 wherein after acceptance of the second supplier to be linked to the first supplier, a fee based on sales of the second supplier's products from the second supplier's product page resulting from consumers linking to the second supplier's product page from the supplier's product page is credited to the first supplier.

4. The method according to claim 1 wherein after acceptance of the second supplier to be linked to the first supplier, a percentage of sales of the first supplier's products from the first supplier's product page resulting from consumers linking to the first supplier's product page from the second supplier's product page is credited to the second supplier.

5. The method according to claim 1 wherein after acceptance of the second supplier to be linked to the first supplier, a fee based on sales of the first supplier's products from the first supplier's product page resulting from consumers linking to the first supplier's product page from the second supplier's product page is credited to the second supplier.

6. The method according to claim 1 wherein said first supplier and said second supplier comprise a group of suppliers among said plurality of suppliers, said suppliers of said group linked on each other's respective product pages.

7. The method according to any of claims 1 to 6 wherein the suppliers comprise manufacturers, each having at least one distribution channel that involves a retail establishment.

8. The method according to any of claims 1 to 6 wherein the suppliers comprise distributors, each having at least one distribution channel that involves a retail establishment.

9. The method according to any of claims 1 to 6 wherein the suppliers comprise vendors, each having at least one distribution channel that involves a retail establishment.

10. A network for coordinating the distribution of products from a plurality of product suppliers to consumers wherein each of said suppliers is an entity having at least one distribution channel that involves a retail establishment, comprising a server comprising
a graphical consumer interface accessible by consumers over the internet configured to display product information including price and availability to consumers for products from said plurality of suppliers and to receive product orders from consumers directly to any of said plurality of suppliers wherein price and availability information for the products of each of said suppliers are organized by product category on a product page of each respective product supplier, wherein the appearance of products and ads on each supplier's product page is under control of the supplier;
the graphical consumer interface configured to enable a consumer to search through the products of a given category by supplier, by product type, by product feature, or by a combination of two or more of these identifiers;
a back room manager accessible only to the suppliers configured to enable a first supplier to select to invite a second supplier to be linked such that:
a search by consumers over the internet on the graphical consumer interface that leads to a product or product of the first supplier will display a link on the first supplier's product page to a related product or products of the second supplier; and
a search by consumers over the internet on the graphical consumer interface that leads to a product or product of the second supplier will display a link on the second supplier's product page to a related product or products of the first supplier;
the back room manager configured to enable the second supplier to accept or refuse to be linked to the first supplier; whereby
if the second supplier accepts to be linked to the first supplier, the back room manager is configured to establish connections on the graphical user interface to link products of the second supplier as suggested products on the first supplier's product page related to products of the first supplier, and to establish connections on the graphical user interface to link products of the first supplier as suggested products on the second supplier's product page related to products of the second supplier.

11. The network according to claim 10 comprising an account manager configured to distribute after acceptance of the second supplier to be linked to the first supplier, a percentage of sales of the second supplier's products from the second supplier's product page resulting from consumers linking to the second supplier's product page from the first supplier's product page is credited to the first supplier.

12. The network according to claim 10 comprising an account manager configured to distribute after acceptance of the second supplier to be linked to the first supplier, a fee based on sales of the second supplier's products from the second supplier's product page resulting from consumers linking to the second supplier's product page from the first supplier's product page is credited to the first supplier.

13. The network according to claim 10 wherein the account manager is configured after acceptance of the second supplier to be linked to the first supplier, a percentage of sales of the first supplier's products from the first supplier's product page resulting from consumers linking to the first supplier's product page from the second supplier's product page is credited to the second supplier.

14. The network according to claim 10 wherein the account manager is configured after acceptance of the second supplier to be linked to the first supplier, a fee based on sales of the first supplier's products from the first supplier's product page resulting from consumers linking to the first supplier's product page from the second supplier's product page is credited to the second supplier.

15. The network according to claim 10 wherein said first supplier and said second supplier comprise a group of suppliers among said plurality of suppliers, said suppliers of said group linked on each other's respective product pages.

16. The network according to any of claims 10 to 15 wherein the suppliers comprise manufacturers, each having at least one distribution channel that involves a retail establishment.

17. The network according to any of claims 10 to 15 wherein the suppliers comprise distributors, each having at least one distribution channel that involves a retail establishment.

18. The method according to any of claims 10 to 15 wherein the suppliers comprise vendors, each having at least one distribution channel that involves a retail establishment.
